(19) United States
(12) Patent Application Publication
(10) Pub. No.: US 2018/0185980 A1
(43) Pub. Date: Jul. 5, 2018

(54) DRESSING TOOL

(71) Applicants: SAINT-GOBAIN ABRASIVES, INC., Worcester, MA (US); SAINT-GOBAIN ABRASIFS, Conflans-Sainte-Honorine (FR)

(72) Inventors: Kevin M. WOLFE, Mills River, NC (US); Elizabeth SKOMRA, Greer, SC (US); Juan ARAIZA, IV, Mission Viejo, CA (US)

(21) Appl. No.: 15/858,595

(22) Filed: Dec. 29, 2017

Related U.S. Application Data
(60) Provisional application No. 62/440,240, filed on Dec. 29, 2016.

(51) Int. Cl. B24B 53/12; B24B 53/047

(52) U.S. Cl. CPC B24B 53/12; B23B 27/20; B24B 53/047

(57) ABSTRACT

The present disclosure relates to a dressing tool. The dressing tool can include a shank having a proximal end and a distal end as well as an abrasive tip. The abrasive tip may include a superabrasive material that may be bonded to the distal end of the shank. The abrasive tip may be tilted relative to a longitudinal axis of the shank.

### CROSS-REFERENCE TO RELATED APPLICATION(S)

This application claims priority under 35 U.S.C. § 119(e) to U.S. Provisional Patent Application No. 62/440,240 entitled “DRESSING TOOL,” by Kevin M. WOLFE et al., filed Dec. 29, 2016, which is assigned to the current assignee hereof and incorporated herein by reference in its entirety.

### FIELD OF THE DISCLOSURE

The present disclosure relates to dressing tools, and methods of making and using such dressing tools.

### BACKGROUND

Various grinding tools are known to those skilled in the art and may include abrasive grains, such as, Cubic boron nitride (CBN) or diamond, included within a bond material, such as, conventional aluminum oxide, silicon carbide, resins, and vitrified materials. It is typical that these grinding tools be dressed to maintain an open and aggressive grinding surface. An open and aggressive surface condition on a tool may be desirable since an open grinding surface is less likely to burn a workpiece and requires less grinding power than a tool having closed, or dull surface.

Manufacturers still require improved dressing tools.

### SUMMARY

According to a first aspect, a dressing tool may include a shank comprising a proximal end and a distal end, an abrasive tip having a superabrasive material and bonded to the distal end of the shank. The abrasive tip may have an abrasive axis where the abrasive tip is positioned at a tilt angle of at least 1 degree relative to a longitudinal axis of the shank.

### BRIEF DESCRIPTION OF THE DRAWINGS

Embodiments are illustrated by way of example and are not limited to the accompanying figures.

FIG. 1A includes an illustration of a side view of an abrasive tip of a conventional dressing tool.

FIG. 1B includes an illustration of a perspective view of a conventional dressing tool.

FIG. 1C includes an illustration of a top-down view of an abrasive tip of a conventional dressing tool.

FIG. 2A includes an illustration of a perspective view of a dressing tool as viewed in a longitudinal plane according to an embodiment.

FIG. 2B includes an illustration of a perspective side-view of a dressing tool as viewed in a lateral plane according to an embodiment.

FIG. 2C includes an illustration of a top-down view of a dressing tool according to an embodiment.

FIG. 3A includes an illustration of a perspective view of a dressing tool as viewed in a longitudinal plane according to an embodiment.

FIG. 3B includes an illustration of a perspective view of a dressing tool as viewed in a lateral plane according to an embodiment.

FIG. 3C includes an illustration of a top-down view of a conventional dressing tool according to an embodiment.

FIG. 4 shows a process flow diagram of an embodiment of a method of making a dressing tool.

FIG. 5A includes an illustration of a top-down view of an abrasive tip according to an embodiment.

FIG. 5B includes an illustration of a top-down view of an abrasive tip according to an embodiment.

FIG. 6 includes an illustration of a perspective view of a superabrasive material according to an embodiment.

FIG. 7A includes an illustration of a perspective view of a superabrasive material according to an embodiment.

FIG. 7B includes an illustration of a side-view of a superabrasive material according to an embodiment.

FIG. 8 includes an illustration of a side-view of a conventional superabrasive material.

FIG. 9 includes an illustration of a perspective view of an embodiment according to Example 2.

Skilled artisans appreciate that elements in the figures are illustrated for simplicity and clarity and have not necessarily been drawn to scale.

### DETAILED DESCRIPTION

The following description in combination with the figures is provided to assist in understanding the teachings of the disclosed shank 105 herein. The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the abrasive arts.

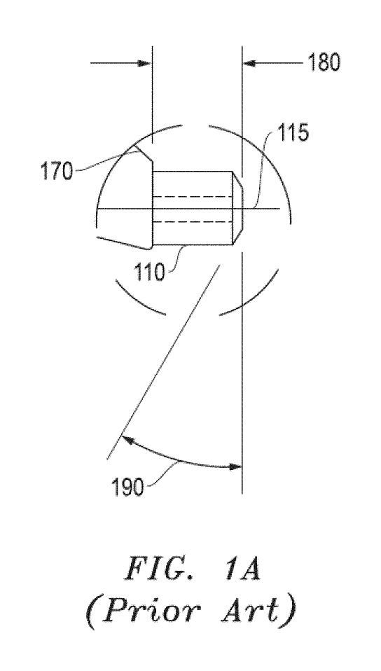

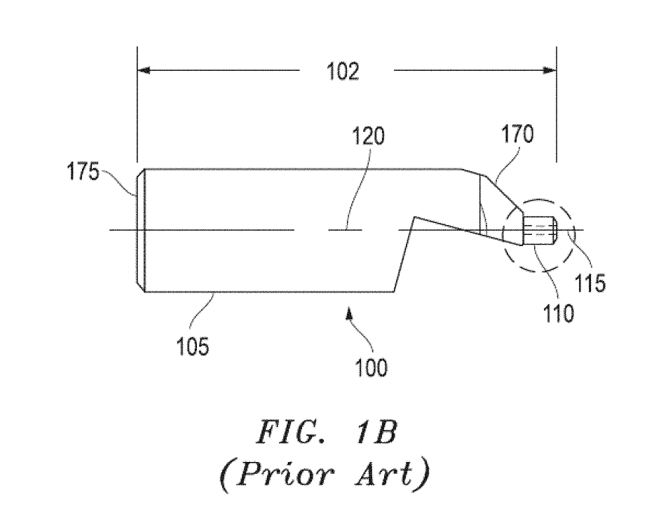

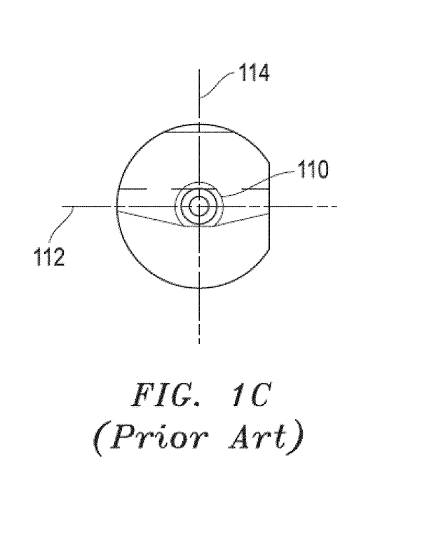

FIGS. 1A-1C include illustrations of a conventional dressing tool 100. As shown in FIG. 1B, the conventional dressing tool 100 may include a shank 105. According to particular embodiments, the shank can include a proximal end 175 and a distal end 170 separated from each other by the length of the body defining the shank 105. According to still other embodiments, the shank 105 may further include a longitudinal axis 120 that extends along and defines the length of the shank 105. According to still other embodiments, the longitudinal axis 120 defines the longest dimension of the shank 105.

According to particular embodiments, the conventional dressing tool 100 may include an abrasive tip 110 including a conventional superabrasive material. In a particular embodiment, the abrasive tip 110 may be located at a distal end 170 of the shank 105 and may include an abrasive axis 115. As shown in FIG. 1C, the abrasive tip 110 may include a lateral plane 112 and a longitudinal plane 114. As shown in FIG. 1B, the abrasive axis 115 is parallel to the longitudinal axis 120. Accordingly, the abrasive tip 110 has a zero degree tilt angle in the lateral plane 112 and longitudinal plane 114 relative to the longitudinal axis 120 of the shank 105.

FIG. 1A is a depiction of a conventional dressing tool abrasive tip 110. As illustrated, the abrasive tip 110 may have an abrasive tip chamfer angle 190 of approximately 30 degrees.

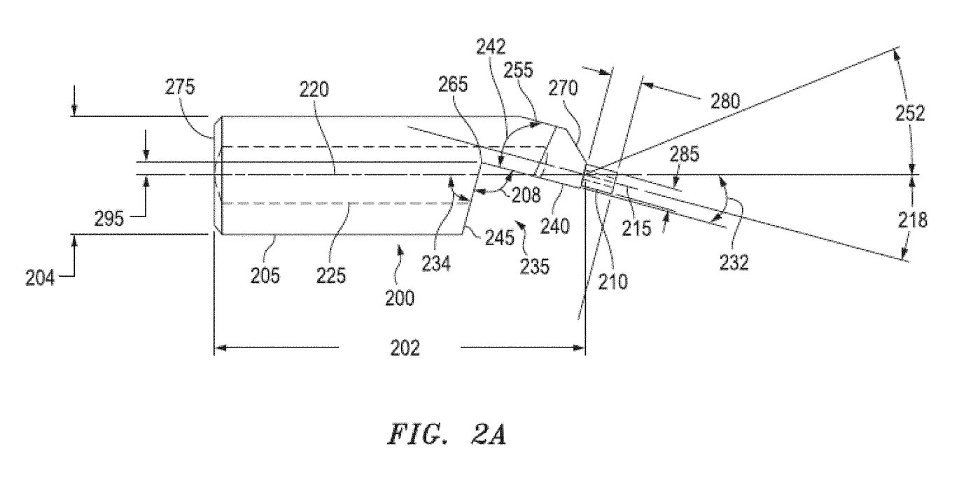

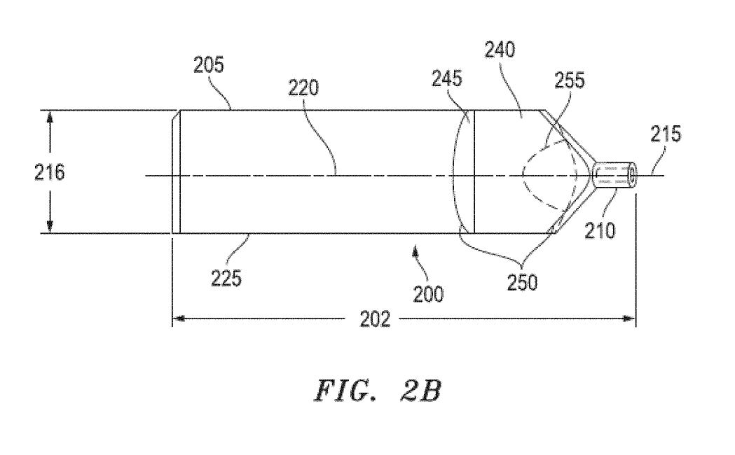

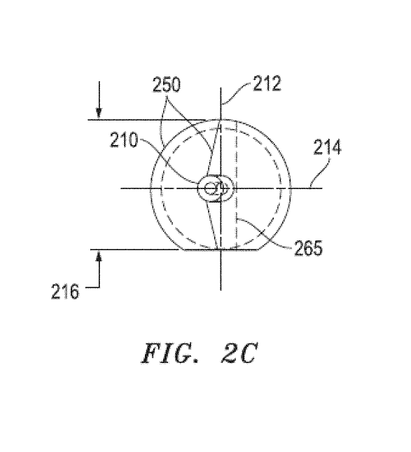

FIGS. 2A-2C include illustrations of dressing tools according to embodiments described herein. According to particular embodiments, the dressing tool 200 may include a shank 205. According to particular embodiments, the shank 205 may include a proximal end 275 and a distal end 270.

According to still other embodiments, the dressing tool 200 may include an abrasive tip 210. In a particular embodiment, the abrasive tip 210 may be located at the distal end 270 of the shank 205.

According to still other embodiments, the dressing tool 200 may include a longitudinal axis 220, which defines the longest dimension of the shank 205. In a particular embodiment, the longitudinal axis 220 includes a longest length including the shank 205 and the abrasive tip 210. In a particular embodiment, the dressing tools 200 may have a longest length within the range of at least 1.5 cm to not greater than 5.5 cm. According to particular embodiments, the shank 205 may have a particular length 202. In a particular embodiment, the length 202 may be in a range of at least 1.0 cm to 5.0 cm.

In a particular embodiment, the proximal end 275 and the distal end 270 of the shank 205 may be tapered. According to one particular embodiment, the distal end 270 may taper to a width approximating the width of the abrasive tip 210. According to still other embodiments, the proximal end 275 and the distal end 270 of the shank 205 may have a truncated cone shape. According to still other embodiments, the distal end 270 of the shank 205 may include a truncated cone shape that may taper to a width that is approximately the same as the width of the abrasive tip 210. In still another embodiment, the proximal end 275 and/or the distal end 270 may have a diameter approximately the same as the diameter of the shank 205.

In a particular embodiment, the shank 205 may include an inorganic material. In a particular embodiment, the shank 205 may include a metal, metal alloy, a ceramic or a combination thereof. According to a particular embodiment the shank 205 may include a metal. According to still other embodiments, the shank 205 may include a metal alloy. According to still other embodiments, the shank 205 may include a ceramic. In a particular embodiment, the shank 205 may include 1215 cold rolled steel.

In a particular embodiment, the shank 205 may include a substantially cylindrical shape. The cylindrical shape may allow the dressing tool 200 to be easily handled and/or placed within a piece of machinery. In a particular embodiment, the shank 205 may include a flat surface 225 extending for at least a portion of a length of the shank 205. In still other embodiments, the flat surface 225 may extend the entire length of the shank 205.

According to a particular embodiment, the shank 205 may have particular dimensions and features that facilitates improved performance of the dressing tool. According to a particular embodiment, the shank 205 may include a width 216 in the range of at least 0.5 cm to not greater than 1.5 cm. According to still other embodiment, the width 216 may be the smallest value extending in a direction perpendicular to the longitudinal axis 220 of the shank 205, as measured at the distal end 270 of the shank 205.

In certain embodiments, the shank 205 may include a notch 235 at the proximal end 275. In still other embodiments, the shank 205 may include a notch 235 at the distal end 270. According to still other embodiments, the shank 205 may include a notch 235 at the proximal end 275 and the distal end 270 of the shank 205.

According to a particular embodiment, the notch 235 may include a top interior surface 240 and a bottom interior surface 245. In a particular embodiment, the top interior surface 240 and bottom interior surface 245 may have a generally semicircular shape. In still other embodiments, the top interior surface 240 and the bottom interior surface 245 may have a generally planar surface. It will be appreciated that other shapes for the top interior surface 240 and the bottom interior surface 245 may be used.

In a particular embodiment, the shank 205 may further include an outer edge 250 that can define a perimeter of the top interior surface 240 and the bottom interior surface 245. In a particular embodiment, the top interior surface 240 and the bottom interior surface 245 may converge at an interior edge 265 within the body of the shank 205. In a particular embodiment, the interior edge 265 may be straight line and may extend from a first point on the outer edge 250 to a second point on the outer edge 250.

In a particular embodiment, the distance between the interior edge 265 and the longitudinal axis 220 can be within the range of at least 0.08 cm to not greater than 0.18 cm.

In a particular embodiments, the outer edge 250 of the top interior surface 240 may be proximal the abrasive tip 210. In certain embodiments, the outer edge 250 may abut the edge of the abrasive tip 210.

In a particular embodiment, the notch 235 may have a positioning angle 208, defined as the angle extending between the top interior surface 240 and the bottom interior surface 245. In a particular embodiment, the notch 235 may define a positioning angle 208 of less than 90 degrees, such as within a range between 10 degrees and 89 degrees. In still other embodiments, the positioning angle 208 can be greater than 90 degrees, such as within a range between 91 degrees and 170 degrees. In still other embodiments, the positioning angle 208 can be 90 degrees.

In a particular embodiment, the top interior surface 240 may be positioned at a specific angle relative to the longitudinal axis 220 of the shank 205 which may facilitate improved operation of the dressing tool 200 compared to conventional dressing tools. In a particular embodiment, the top interior surface 240 may be positioned at an angle 232 not greater than 20 degrees relative to the longitudinal axis 220 of the shank 205. In still other embodiments, the angle 232 of the top interior surface 240 relative to the longitudinal axis 220 may be not greater than 18 degrees, such as not greater than 15 degrees, or not greater than 12 degrees, or not greater than 10 degrees, or not greater than 8 degrees, or not greater than 6 degrees, or even not greater than 4 degrees. In at least one embodiment, the angle 232 of the top interior surface 240 relative to the longitudinal axis 220 may be the same as a tilt angle 218 of the abrasive tip 210 relative to the longitudinal axis 220 of the shank 205, which will be described in more detail herein.

According to a particular embodiment, the bottom interior surface 245 may be positioned at a particular angle 234 relative to the longitudinal axis 220, which may facilitate improved operations of the dressing tool. In a particular embodiment, the angle 234 between the bottom interior surface 245 and the longitudinal axis 220 can be at least 45 degrees, such as at least 50 degrees, such as at least 60 degrees, or even at least 70 degrees.

In a particular embodiment, the shank 205 may have an upper exterior surface 255 positioned near or at the distal end 270 of the shank 205. In a particular embodiment, the upper exterior surface 255 may be parallel to the top interior surface 240. In a particular embodiment, the upper exterior surface 255 may define an angle 242 relative to the longitudinal axis 220 of the shank 205 that can be the same as the angle 232 between the top interior surface 240 and the longitudinal axis 220. In a particular embodiment, at least one of the upper exterior surface 255 and the top interior surface 240 may be parallel to the abrasive axis 215.

In still other embodiments, the dressing tool 200 may include an abrasive tip 210 that may be affixed to the distal end 270 of the shank 205. In particular embodiments, the abrasive tip 210 of the dressing tool 200 may be bonded to the shank 205 at the distal end 270 with a bonding material. In a particular embodiment, the bonding material may include a carbide. In still other embodiments, the bonding material may include titanium. In a particular embodiment, the bonding material may include titanium carbide. In still other embodiments, the abrasive tip 210 of the dressing tool 200 may be bonded to the shank 205 with titanium carbide. In still other embodiments, the bonding material may comprise a braze. In still other embodiments, the bonding material may consist essentially of a titanium carbide matrix applied via vacuum brazing. In still other embodiments, the bonding material may be formed from a bonding precursor material comprising titanium hydride. In still other embodiments, the bonding precursor material reacts with at least a portion of the material of the abrasive tip 210 to form titanium carbide.

In a particular embodiment, the abrasive tip 210 may be made of a particular material and have a particular shape and size that may facilitate improved performance of the dressing tool 200. In a particular embodiment, the abrasive tip 210 may include a monocrystalline material. In another embodiment, the entirety of the abrasive tip 210 may include a monocrystalline material. In still other embodiments, the abrasive tip 210 may include a polycrystalline material. In still other embodiments, the entirety of the abrasive tip 210 may include a polycrystalline material.

In a particular embodiment, the abrasive tip 210 may include a superabrasive material such as, but not limited to, diamond, cubic boron nitride, or a combination thereof. In a particular embodiment, the abrasive tip 210 may include diamond, and more particularly, may consist essentially of diamond. In still other embodiments, the abrasive tip 210 may include a synthetic diamond. The synthetic diamond may have a particular shape, hardness, and friability that may facilitate improved performance of the tools according to the embodiments herein.

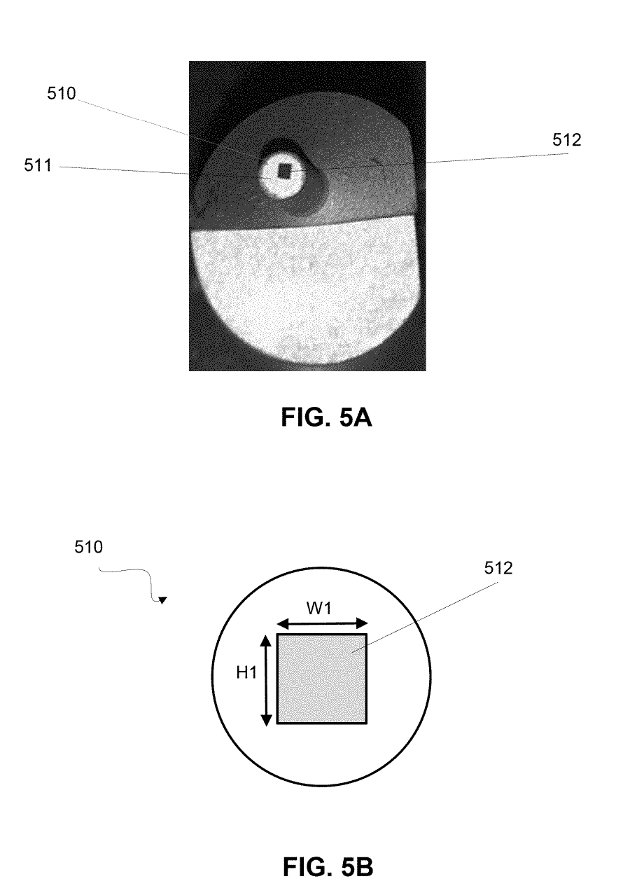

FIG. 5A illustrates a top-down view of an abrasive tip 510 formed according to an embodiment. The abrasive tip 510 may include a bonding material 511 and a superabrasive material 512.

FIG. 5B illustrates a top-down view of an abrasive tip 510 formed according to an embodiment. In a particular embodiment, the superabrasive material 512 may have a particular, desirable cross-sectional shape and three-dimensional shape. In a particular embodiment, the superabrasive material 512 may have substantially any contemplated cross-sectional shape. More particularly, the superabrasive material may have a cross-sectional shape in a plane defined by a length L1 and a width W1, which may be viewed top-down, where the shape is selected from the group of triangular, quadrilateral, rectangular, trapezoidal, pentagonal, hexagonal, heptagonal, octagonal, ellipsoids, a Greek alphabet letter, a Latin alphabet character, a Russian alphabet character, a Kanji character, complex polygonal shapes, irregular shaped contours, and any combination thereof.

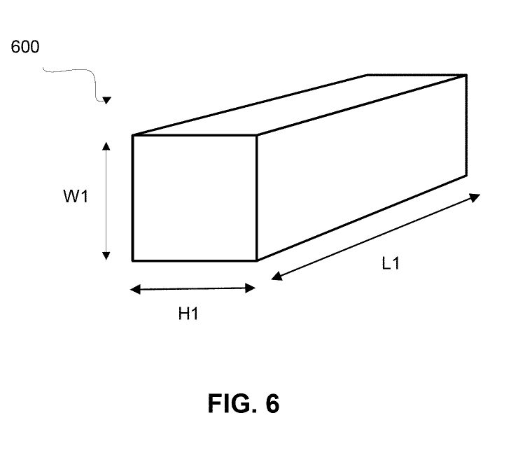

FIG. 6 illustrates a perspective view of a superabrasive material 600. In a particular embodiment, the superabrasive material 600 may have a particular height H1. For example, the height H1 of superabrasive material 600 may be at least about 0.05 mm, such as, at least about 0.1 mm, or at least about 0.15 mm or at least about 0.2 mm or at least about 0.3 mm or at least about 0.4 mm or at least about 0.5 mm or even at least about 0.6 mm. According to still other embodiments, the height H1 of superabrasive material 600 may be not greater than 5 mm, such as, not greater than about 4 mm, or not greater than 3 mm or not greater than 2 mm or not greater than 1.9 mm or not greater than 1.6 mm or not greater than 1.5 mm or not greater than 1.4 mm or not greater than 1.3 mm or not greater than 1.2 mm or even not greater than 1.1 mm. It will be appreciated the height H1 of superabrasive material 600 may be any value within a range between the minimum and maximum values noted above. It will be further appreciated the height H1 of superabrasive material 600 may be any value between any of the minimum and maximum values noted above.

In still other embodiments, the superabrasive material 600 may have a particular width W1. For example, the width W1 of superabrasive material 600 may be at least about 0.05 mm, such as, at least about 0.1 mm, or at least about 0.15 mm or at least about 0.2 mm or at least about 0.3 mm or at least about 0.4 mm or at least about 0.5 mm or even at least about 0.6 mm. According to still other embodiments, the width W1 of superabrasive material 600 may be not greater than 5 mm, such as, not greater than about 4 mm, or not greater than 3 mm or not greater than 2 mm or not greater than 1.9 mm or not greater than 1.6 mm or not greater than 1.5 mm or not greater than 1.4 mm or not greater than 1.3 mm or not greater than 1.2 mm or even not greater than 1.1 mm. It will be appreciated the width W1 of superabrasive material 600 may be any value within a range between the minimum and maximum values noted above. It will be further appreciated the width W1 of superabrasive material 600 may be any value between any of the minimum and maximum values noted above.

In still other embodiments, the superabrasive material 600 may have a particular length L1. In a particular embodiment, the length L1 is the longest dimension of the superabrasive material 600. For example, the length L1 of superabrasive material 600 may be at least about 1 mm, such as, at least about 1.5 mm, or at least about 2 mm or at least about 2.5 mm or at least about 3 mm or at least about 3.5 mm or at least about 4 mm or even at least about 4.5 mm. According to still other embodiments, the length L1 of superabrasive material 600 may be not greater than 6 mm, such as, not greater than about 5 mm, or not greater than 4 mm or even not greater than 3.5 mm. It will be appreciated the length L1 of superabrasive material 600 may be any value within a range between the minimum and maximum values noted above. It will be further appreciated the length L1 of superabrasive material 600 may be any value between any of the minimum and maximum values noted above.

According to a particular embodiment, the superabrasive material 600 can have a primary aspect ratio, which is a ratio expressed as length:width having a value of at least 1.1:1. In other instances, the superabrasive material 600 can have a primary aspect ratio (l:w) of at least about 1.5:1, such as at least about 2:1, at least about 2.5:1 or even at least about 3:1. Still, in other instances, the superabrasive material 600 can have a primary aspect ratio (l:w) that is not greater than about 10:1, such as not greater than 9:1, not greater than about 8:1, or even not greater than about 5:1. It will be appreciated that the superabrasive material 600 can have a primary aspect ratio within a range between any of the ratios noted above.

In addition to the primary aspect ratio, the superabrasive material 600 can have a secondary aspect ratio, which can be defined as a ratio of length:height. In certain instances, the secondary aspect ratio can be within a range between about 10:1 and about 1.1:1, such as between about 8:1 and about 2:1, or even between about 5:1 and about 3:1.

In accordance with another embodiment, the superabrasive material 600 can have a tertiary aspect ratio, defined by the ratio width:height. The tertiary aspect ratio of the superabrasive material 600 can be within a range between about 10:1 and about 1:1, such as between 8:1 and about 1:1, such as between about 6:1 and about 1:1, or even between about 4:1 and about 1:1.

According to still other embodiments, the superabrasive material 600 may have a particular consistency in its cross-sectional shape along a length L1 of the body. For example, the superabrasive material 600 may have a particular variation in the width of the body along the length of the superabrasive material 600. Without wishing to be tied to a particular theory, it is noted that the consistency in certain dimensions of the superabrasive material may facilitate improved performance of the abrasive article. For example, in a particular embodiment, the superabrasive material 600 can have a width variation not greater than 10% of the average width along at least 50% of the length L1 of the superabrasive material 600. That is, the width variation is not greater than 10% of the average width value for at least half of the total length L1 of the superabrasive material 600. The average width of the superabrasive material 600 can be determined by taking at least 5 equally spaced measurements along the length of the superabrasive material. The maximum variation can be calculated by (Wn/Wa)×100%, wherein Wn represents a given width measurement and Wa represents the average width of the superabrasive body 600. According to still other embodiments, the superabrasive material 600 may have a width variation not greater than 10%, such as not greater than 9% or not greater than 8% or not greater than 7% or not greater than 6% or not greater than 5% or not greater than 4% or not greater than 3% or not greater than 2% or not greater than 1% of the average width along at least 50% of the length L1.

Still, in another embodiment, the width variation may be not greater than 10% for a greater length of the total length L1 of the superabrasive material 600. For example, the width variation may be not greater than 10% for at least 60% of the length L1, such as at least 70% of the length L1, or at least 80% of the length L1 or at least 90% of the length L1, or at least 95% of the length L1 or even at least 99% of the length L1 of the superabrasive material 600.

In still other embodiments, the superabrasive material 600 may have a width variation not greater than 8% of the average width along at least 50% of the length L1 of the superabrasive material 600. According to still other embodiments, the superabrasive material 600 may have a width variation not greater than 6%, such as not greater than 5% or not greater than 4% or not greater than 3% or even not greater than 2% of the average width along at least 50% of the length L1 of the superabrasive material 600. According to still other embodiments, the superabrasive material 600 may have a width variation not greater than 6%, such as not greater than 5% or not greater than 4% or not greater than 3% or even not greater than 2% of the average width along at least 60% of the length L1 of the superabrasive material 600. According to still other embodiments, the superabrasive material 600 may have a width variation not greater than 6%, such as not greater than 5% or not greater than 4% or not greater than 3% or even not greater than 2% of the average width along at least 70% of the length L1 of the superabrasive material 600. According to still other embodiments, the superabrasive material 600 may have a width variation not greater than 6%, such as not greater than 5% or not greater than 4% or not greater than 3% or even not greater than 2% of the average width along at least 80% of the length L1 of the superabrasive material 600. According to still other embodiments, the superabrasive material 600 may have a width variation not greater than 6%, such as not greater than 5% or not greater than 4% or not greater than 3% or even not greater than 2% of the average width along at least 90% of the length L1 of the superabrasive material 600. According to still other embodiments, the superabrasive material 600 may have a width variation not greater than 6%, such as not greater than 5% or not greater than 4% or not greater than 3% or even not greater than 2% of the average width along at least 99% of the length L1 of the superabrasive material 600.

According to a particular embodiment, the superabrasive material 600 may have a particular variation in the height of the body along the length of the superabrasive material 600. Without wishing to be tired to a particular theory, it is noted that the consistency in certain dimensions of the superabrasive material may facilitate improved performance of the abrasive article. For example, in a particular embodiment, the superabrasive material 600 can have a height variation not greater than 10% of the average height along at least 50% of the length L1 of the superabrasive material 600. That is, the height variation is not greater than 10% of the average height value for at least half of the total length L1 of the superabrasive material 600. The average height of the superabrasive material 600 can be determined by taking at least 5 equally spaced measurements along the length of the of the superabrasive material. The maximum variation can be calculated by (Hn/Ha)×100%, wherein Hn represents a given height measurement and Ha represents the average height of the superabrasive body 600. According to still other embodiments, the superabrasive material 600 may have a height variation not greater than 10%, such as not greater than 9% or not greater than 8% or not greater than 7% or not greater than 6% or not greater than 5% or not greater than 4% or not greater than 3% or not greater than 2% or not greater than 1% of the average height along at least 50% of the length L1 of the superabrasive material 600.

Still, in another embodiment, the height variation may not be greater than 10% for a greater length of the total length L1 of the superabrasive material 600. For example, the height variation may be not greater than 10% for at least 60% of the length L1, such as, at least 70% of the length L1, or at least 80% of the length L1 or at least 90% of the length L1, or at least 95% of the length L1 or even at least 99% of the length L1 of the superabrasive material 600.

In still other embodiments, the superabrasive material 600 may have a height variation not greater than 8% of the average height along at least 50% of the length L1 of the superabrasive material 600. According to still other embodiments, the superabrasive material 600 may have a height variation not greater than 6%, such as not greater than 5% or not greater than 4% or not greater than 3% or even not greater than 2% of the average height along at least 50% of the length L1 of the superabrasive material 600. According to still other embodiments, the superabrasive material 600 may have a height variation not greater than 6%, such as not greater than 5% or not greater than 4% or not greater than 3% or even not greater than 2% of the average height along at least 60% of the length L1 of the superabrasive material 600. According to still other embodiments, the superabrasive material 600 may have a height variation not greater than 6%, such as not greater than 5% or not greater than 4% or not greater than 3% or even not greater than 2% of the average height along at least 70% of the length L1 of the superabrasive material 600. According to still other embodiments, the superabrasive material 600 may have a height variation not greater than 6%, such as not greater than 5% or not greater than 4% or not greater than 3% or even not greater than 2% of the average height along at least 80% of the length L1 of the superabrasive material 600. According to still other embodiments, the superabrasive material 600 may have a height variation not greater than 6%, such as not greater than 5% or not greater than 4% or not greater than 3% or even not greater than 2% of the average height along at least 90% of the length L1 of the superabrasive material 600. According to still other embodiments, the superabrasive material 600 may have a height variation not greater than 6%, such as not greater than 5% or not greater than 4% or not greater than 3% or even not greater than 2% of the average height along at least 99% of the length L1 of the superabrasive material 600.

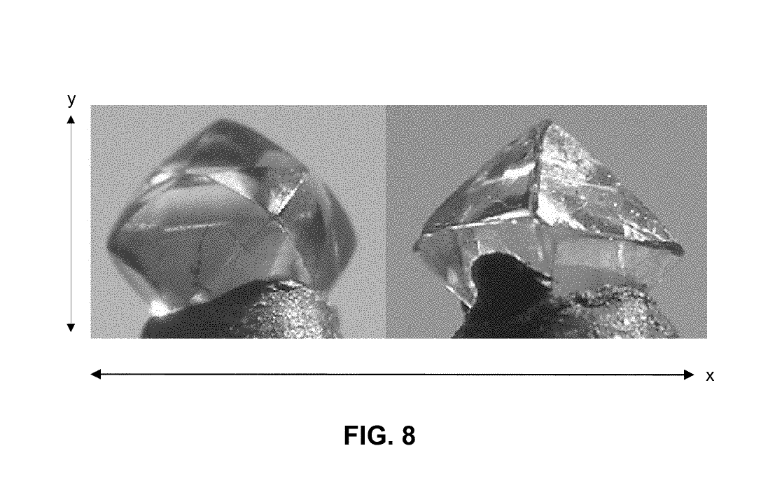

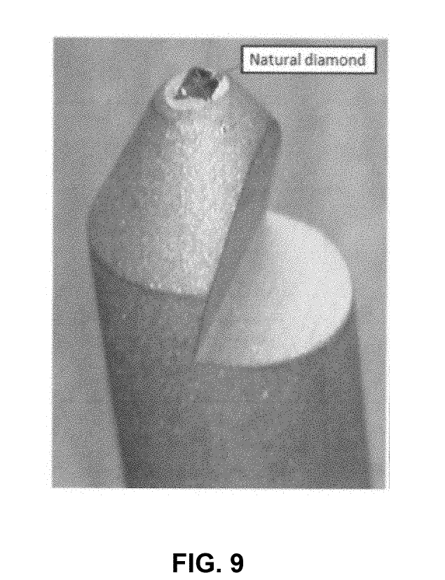

FIG. 8 includes an image of a natural diamond for use in conventional tools as a superabrasive material. The natural diamonds of FIG. 8 have a length along a y-axis and a varying width and height along an x-axis. Notably, the natural diamond has a shape that results in significant variation in the width and height along the length of the body of the diamond.

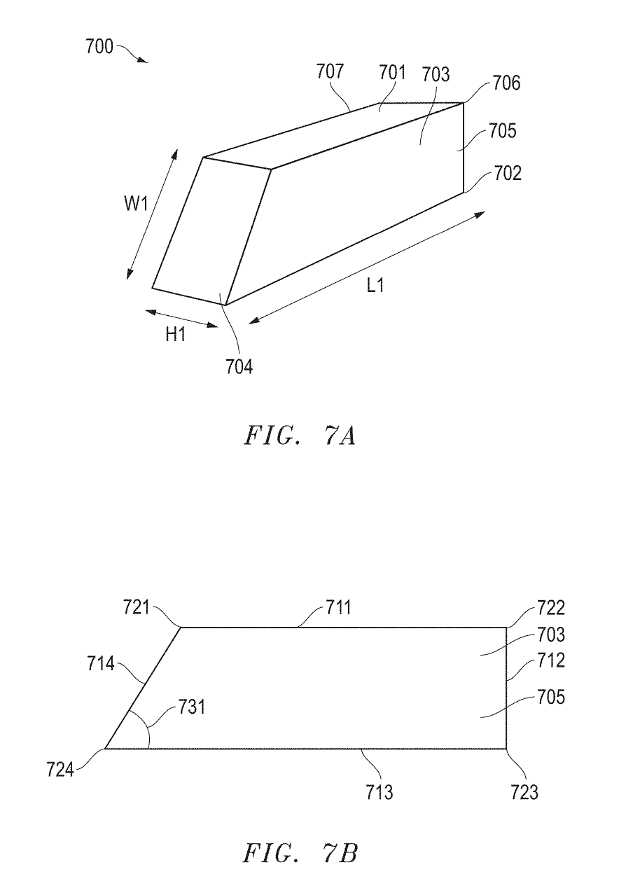

According to still other embodiments, the superabrasive material may include a tapered portion. FIG. 7A includes a perspective view illustration of a superabrasive material 700 according to an embodiment. As illustrated, the superabrasive material can include an upper major surface 701 and a bottom major surface 702 (not shown) opposite the upper major surface 701. The upper major surface 701 and the bottom major surface 702 can be separated from each other by at least one side surface 703, which may include one or more discrete side surface portions, including for example, a first portion 704 of the side surface 703, a second portion 705 of the side surface 703, a third portion 706 of the side surface 703 (not shown), and a fourth portion 707 of the side surface 703 (not shown).

FIG. 7B includes a side-view illustration of a second portion 705 of the side surface 703 of the superabrasive material 700 according to an embodiment. According to a particular embodiment, the second portion 705 may include a first linear section 711 extending between a first corner 721 and a second corner 722. According to a particular embodiment, the second portion 705 may include a second linear section 712 extending between a second corner 722 and a third corner 723. According to a particular embodiment, the second portion 705 may include a third linear section 713 extending between a third corner 723 and a fourth corner 724. According to a particular embodiment, the second portion 705 may include a fourth linear section 714 extending between a fourth corner 724 and a first corner 721. According to a particular embodiment, the third linear section 713 and the fourth linear section 714 can define a first interior angle 731 having an acute value. It will be appreciated that the superabrasive material 700 may have any characteristics described herein with reference to FIG. 6.

In a particular embodiment, the abrasive tip 210 may have a length 280 and a width 285, wherein the length 280 defines the longest dimension along an abrasive axis 215 of the abrasive tip 210. According to a particular embodiment, the length 280 of the abrasive tip 210 may be at least about 1 mm, such as, at least about 1.5 mm, or at least about 2 mm or at least about 2.5 mm or at least about 3 mm or at least about 3.5 mm or at least about 4 mm or even at least about 4.5 mm. According to still other embodiments, the length 280 of the abrasive tip 210 may be not greater than 6 mm, such as, not greater than about 5 mm, or not greater than 4 mm or even not greater than 3.5 mm. It will be appreciated the length 280 of the abrasive tip 210 may be any value within a range between the minimum and maximum values noted above. It will be further appreciated the length 280 of the abrasive tip 210 may be any value between any of the minimum and maximum values noted above

According to still other embodiments, the width 285 of the abrasive tip 210 may be at least about 0.1 mm, such as, at least about 0.3 mm, or at least about 0.5 mm or at least about 1.0 mm or at least about 1.2 mm or at least about 1.3 mm or at least about 1.5 mm or even at least about 1.6 mm. According to still other embodiments, the width 285 of the abrasive tip 210 may be not greater than 4 mm, such as, not greater than about 3.5 mm, or not greater than 3 mm or not greater than 2.5 mm or not greater than 2.1 mm or even not greater than 2.0 mm. It will be appreciated the width 285 of the abrasive tip 210 may be any value within a range between the minimum and maximum values noted above. It will be further appreciated the width 285 of the abrasive tip 210 may be any value between any of the minimum and maximum values noted above.

In a particular embodiment, the abrasive tip 210, and notably, the abrasive axis 215 of the abrasive tip 210 may be angled relative to the longitudinal axis 220 of the shank 205, which may facilitate improved performance of the dressing tool 200. As illustrated in FIGS. 2A-2C, the abrasive tip 210 may have an abrasive axis 215 defining the longitudinal axis of the abrasive tip 210. In a particular embodiment, the abrasive tip 210 may be angled within a lateral plane 214, longitudinal plane 212, or a combination thereof. In a particular embodiment, the abrasive tip 210 may be angled within a lateral plane 214. In still another embodiment, the abrasive tip 210 may be angled within a longitudinal plane 212. As illustrated in FIGS. 2A-2C and most clearly illustrated in FIG. 2C, the abrasive tip 210 may be angled relative to the longitudinal axis 220 of the shank 205 within the lateral plane 214, such that a lateral tilt angle 218 is defined. According to a particular embodiment, the lateral tilt angle 218 may be at least 1 degree, such as at least 2 degrees or at least 3 degrees or at least 4 degrees or at least 5 degrees, or at least 6 degrees or at least 7 degrees or at least 8 degrees or at least 9 degrees or at least 10 degrees or at least 11 degrees or at least 12 degree or at least 13 degree or at least 14 degrees or at least 15 degrees or at least 16 degrees or at least 17 degrees or at least 18 degrees or at least 19 degrees or at least 20 degrees or at least 21 degrees or at least 22 degrees or at least 23 degrees or at least 24 degrees or at least 25 degrees or at least 26 degrees or at least 27 degrees or at least 28 degrees or at least 29 degrees or at least 30 degrees. In still other embodiments, the lateral tilt angle 218 may be not greater than 30 degrees, such as not greater than 29 degrees or not greater than 28 degrees or not greater than 27 degrees or not greater than 26 degrees or not greater than 25 degrees or not greater than 24 degrees or not greater than 23 degrees or not greater than 22 degrees or not greater than 21 degrees or not greater than 20 degrees or not greater than 19 degrees or not greater than 18 degrees or not greater than 17 degrees or not greater than 16 degrees or not greater than 15 degrees or not greater than 14 degrees or not greater than 13 degrees or not greater than 12 degrees or not greater than 11 degrees or not greater than 10 degrees or not greater than 9 degrees or not greater than 8 degrees or not greater than 7 degrees or not greater than 6 degrees or not greater than 5 degrees or not greater than 4 degrees or not greater than 3 degrees or not greater than 2 degrees or not greater than 1 degree. It will be appreciated that the lateral tilt angle 218 can be within a range including any of the minimum and maximum values noted above, including for example, but not limited to within a range of at least 1 degree and not greater than 30 degrees or within a range of at least 5 degrees and not greater than 25 degrees or within a range of at least 8 degrees and not greater than 20 degrees or within a range of at least 10 degrees and not greater than 18 degrees or within a range of at least 12 degrees and not greater than 16 degrees.

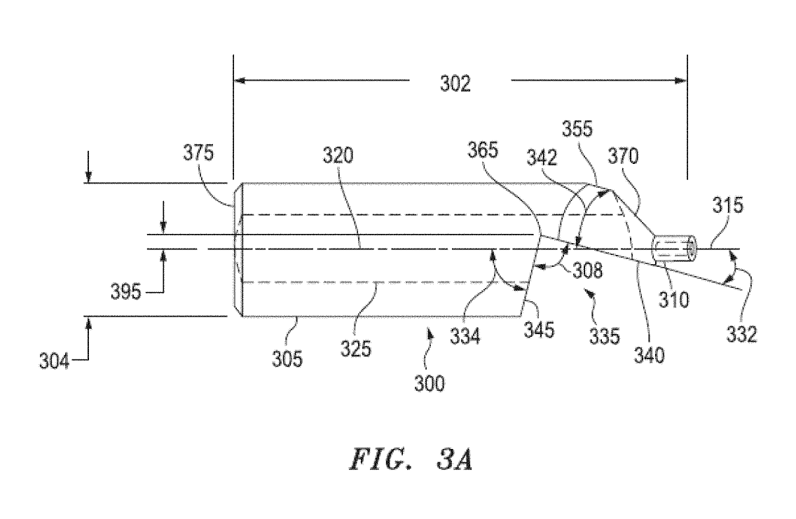

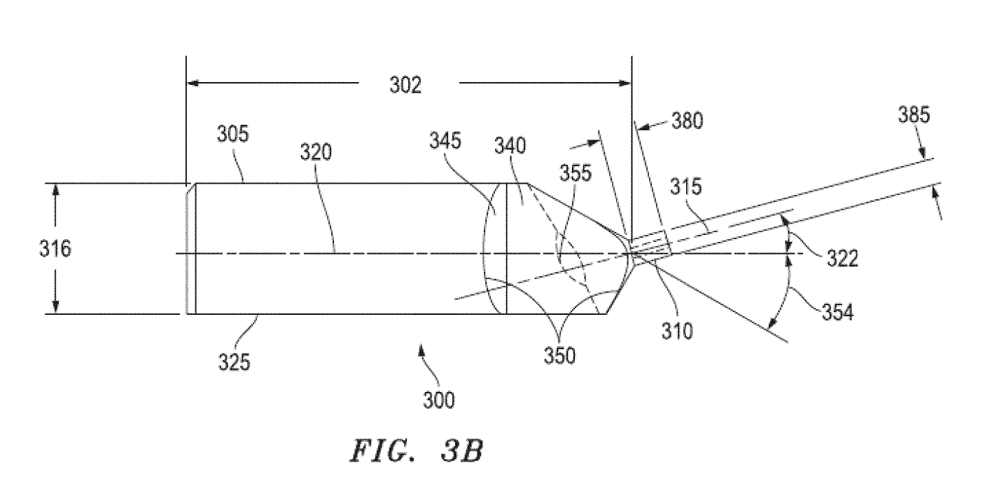

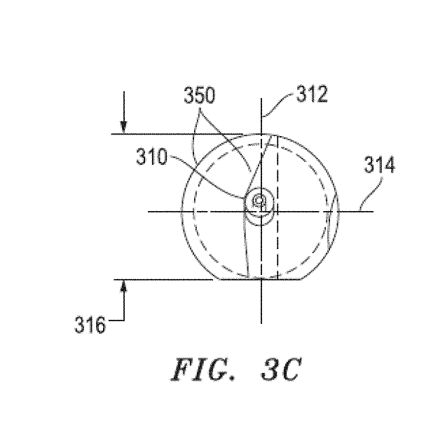

FIGS. 3A-3C include illustrations of a dressing tool 300 according to embodiments described herein. It will be appreciated that the dressing tool 300 and components described in reference to the dressing tool 300 may have any of the characteristics described herein with reference to corresponding components in FIGS. 2A-2C. In a particular embodiment, the dressing tool 300 may include a shank 305 with a proximal end 375 and a distal end 370 and having any of the properties of similar features described in accordance with the dressing tool 200 of FIGS. 2A-2C. In a particular embodiment, the dressing tool 300 may further include a notch 335, a top interior surface 340, a bottom interior surface 345, an outer edge 350, an interior edge 365, upper exterior surface, 355 and positioning angles 308, 332, and 334, which may have any of the properties of similar features described in accordance with the dressing tool 200 of FIGS. 2A-2C.

As illustrated in FIGS. 3A-3C, the dressing tool 300 may include an abrasive tip 310 that may be affixed to the distal end 370 of the shank 305 and may be approximately cylindrical in shape. In this particular embodiment, the abrasive tip 310 of the dressing tool 300 has a different lateral tilt angle and longitudinal tilt angle compared to the abrasive tip 210 of the dressing tool 200.

According to a particular embodiment, the abrasive tip 310, and notably, the abrasive axis 315 of the abrasive tip 310 may be angled relative to the longitudinal axis 320 of the shank 305, which may facilitate improved performance of the dressing tool 300. In a particular embodiment, the abrasive tip 310 may have an abrasive axis 315 defining the longitudinal axis of the abrasive tip 310. In a particular embodiment, the abrasive tip 310 may be angled within the longitudinal plane 312, such that a longitudinal tilt angle 322 is defined. According to a particular embodiment, the longitudinal tilt angle 322 may be at least 1 degree, such as at least 2 degrees or at least 3 degrees or at least 4 degrees or at least 5 degrees, or at least 6 degrees or at least 7 degrees or at least 8 degrees or at least 9 degrees or at least 10 degrees or at least 11 degrees or at least 12 degrees or at least 13 degrees or at least 14 degrees or at least 15 degrees or at least 16 degrees or at least 17 degrees or at least 18 degrees or at least 19 degrees or at least 20 degrees or at least 21 degrees or at least 22 degrees or at least 23 degrees or at least 24 degrees or at least 25 degrees or at least 26 degrees or at least 27 degrees or at least 28 degrees or at least 29 degrees or at least 30 degrees. In still another embodiment, the longitudinal tilt angle 322 may not be greater than 30 degrees, such as not greater than 29 degrees or not greater than 28 degrees or not greater than 27 degrees or not greater than 26 degrees or not greater than 25 degrees or not greater than 24 degrees or not greater than 23 degrees or not greater than 22 degrees or not greater than 21 degrees or not greater than 20 degrees or not greater than 19 degrees or not greater than 18 degrees or not greater than 17 degrees or not greater than 16 degrees or not greater than 15 degrees or not greater than 14 degrees or not greater than 13 degrees or not greater than 12 degrees or not greater than 11 degrees or not greater than 10 degrees or not greater than 9 degrees or not greater than 8 degrees or not greater than 7 degrees or not greater than 6 degrees or not greater than 5 degrees or not greater than 4 degrees or not greater than 3 degrees or not greater than 2 degrees or not greater than 1 degree. It will be appreciated that the longitudinal tilt angle 322 can be within a range including any of the minimum and maximum values noted above, including for example, but not limited to within a range of at least 1 degree and not greater than 30 degrees or within a range of at least 5 degrees and not greater than 25 degrees or within a range of at least 8 degrees and not greater than 20 degrees or within a range of at least 10 degrees and not greater than 18 degrees or within a range of at least 11 degrees and not greater than 17 degrees or within a range of at least 12 degrees and not greater than 16 degrees or within a range of at least 11 degrees and not greater than 15 degrees or within a range of at least 12 degrees and not greater than 15 degrees.

Moreover, unlike the abrasive tip 210 of the dressing tool 200, the abrasive tip 310 of the dressing tool 300 has approximately a 0 degree lateral tilt angle, such that the abrasive axis 315 of the abrasive tip 310 is aligned and parallel to the longitudinal axis 320 of the shank 305. In a particular embodiment, the dressing tool 300 has a lateral tilt angle of approximately 0 degrees.

It will be appreciated that a dressing tool can be made having a combination of a lateral tilt angle of 1 degree or greater and a longitudinal tilt angle of 1 degree or greater. Moreover, while the foregoing has made reference to a lateral tilt angle having a positive value, it will be appreciated that tilting of the abrasive tip in the opposite direction as illustrated in FIGS. 2A-2C can result in a negative lateral tilt angle. The dressing tools of the embodiments herein can also include a negative lateral tilt angle within a range equivalent to the range of positive lateral tilt angles defined in accordance with the embodiment of FIGS. 2A-2C. As such, one or more embodiments herein may include an abrasive tip having a lateral tilt angle 218 of at least −1 degree, such as at least −2 degrees or at least −3 degrees or at least −4 degrees or at least −5 degrees, or at least −6 degrees or at least −7 degrees or at least −8 degrees or at least −9 degrees or at least −10 degrees or at least −11 degrees or at least −12 degree or at least −13 degree or at least −14 degrees or at least −15 degrees or at least −16 degrees or at least −17 degrees or at least −18 degrees or at least −19 degrees or at least −20 degrees or at least −21 degrees or at least −22 degrees or at least −23 degrees or at least −24 degrees or at least −25 degrees or at least −26 degrees or at least −27 degrees or at least −28 degrees or at least −29 degrees or at least −30 degrees. In one non-limiting embodiment, the lateral tilt angle 318 may not be greater than −30 degrees, such as not greater than −29 degrees or not greater than −28 degrees or not greater than −27 degrees or not greater than −26 degrees or not greater than −25 degrees or not greater than −24 degrees or not greater than −23 degrees or not greater than −22 degrees or not greater than −21 degrees or not greater than −20 degrees or not greater than −19 degrees or not greater than −18 degrees or not greater than −17 degrees or not greater than −16 degrees or not greater than −15 degrees or not greater than −14 degrees or not greater than −13 degrees or not greater than −12 degrees or not greater than −11 degrees or not greater than −10 degrees or not greater than −9 degrees or not greater than −8 degrees or not greater than −7 degrees or not greater than −6 degrees or not greater than −5 degrees or not greater than −4 degrees or not greater than −3 degrees or not greater than −2 degrees or not greater than −1 degree. It will be appreciated that the lateral tilt angle 218 can be within a range including any of the minimum and maximum values noted above, including for example, but not limited to within a range of −1 degree and −30 degrees or within a range of −5 degrees and −25 degrees or within a range of −8 degrees and −20 degrees.

Additionally, while the foregoing has made reference to a longitudinal tilt angle having positive values, it will be appreciated that the abrasive tip can be angled in the opposite direction as illustrated in FIGS. 3A-3C, which can result in a negative longitudinal tilt angle. The dressing tools of the embodiments herein can also include a negative longitudinal tilt angles within a range equivalent to the range of positive longitudinal tilt angles defined in accordance with the embodiment of FIGS. 2A-2C. As such, one or more embodiments herein may include an abrasive tip having a longitudinal tilt angle 322 of at least −1 degree, such as at least −2 degrees or at least −3 degrees or at least −4 degrees or at least −5 degrees, or at least −6 degrees or at least −7 degrees or at least −8 degrees or at least −9 degrees or at least −10 degrees or at least −11 degrees or at least −12 degree or at least −13 degree or at least −14 degrees or at least −15 degrees or at least −16 degrees or at least −17 degrees or at least −18 degrees or at least −19 degrees or at least −20 degrees or at least −21 degrees or at least −22 degrees or at least −23 degrees or at least −24 degrees or at least −25 degrees or at least −26 degrees or at least −27 degrees or at least −28 degrees or at least −29 degrees or at least −30 degrees. In one non-limiting embodiment, the longitudinal tilt angle 322 may not be greater than −30 degrees, such as not greater than −29 degrees or not greater than −28 degrees or not greater than −27 degrees or not greater than −26 degrees or not greater than −25 degrees or not greater than −24 degrees or not greater than −23 degrees or not greater than −22 degrees or not greater than −21 degrees or not greater than −20 degrees or not greater than −19 degrees or not greater than −18 degrees or not greater than −17 degrees or not greater than −16 degrees or not greater than −15 degrees or not greater than −14 degrees or not greater than −13 degrees or not greater than −12 degrees or not greater than −11 degrees or not greater than −10 degrees or not greater than −9 degrees or not greater than −8 degrees or not greater than −7 degrees or not greater than −6 degrees or not greater than −5 degrees or not greater than −4 degrees or not greater than −3 degrees or not greater than −2 degrees or not greater than −1 degree. It will be appreciated that the longitudinal tilt angle 322 can be within a range including any of the minimum and maximum values noted above, including for example, but not limited to within a range of −1 degree and −30 degrees or within a range of −5 degrees and −25 degrees or within a range of −8 degrees and −20 degrees.

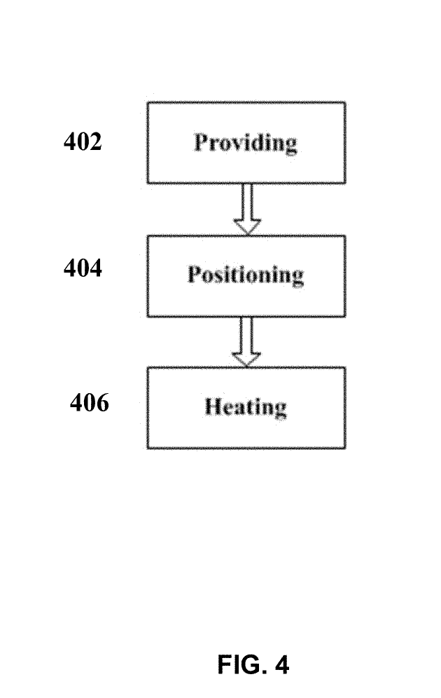

FIG. 4 illustrates a process flow diagram of an embodiment of a method of making a dressing tool according to an embodiment described herein. In a particular embodiment, the dressing tools 200 or 300 may be made by first, at step 402, providing a shank and an abrasive tip. In a particular embodiment, the abrasive tip may be positioned at the distal end of the shank.

In still other embodiments, the process may continue at step 404 by positioning a bond precursor material around an abrasive tip at an area of attachment of the abrasive tip to the shank. In still other embodiments, the bond precursor material may be a metal-containing powder, such as titanium hydride.

In a particular embodiment, the process continues at step 406 by heating the dressing tool and bond precursor material to a temperature sufficient to melt the powder and bond the abrasive tip to the shank.

In still another embodiment, step 402 includes providing a shank and an abrasive tip. In a particular embodiment, the bond precursor material may undergo a chemical reaction when exposed to the heat. In a particular embodiment, the titanium hydride may react with a portion of the material of the abrasive to form titanium carbide, which may aid in binding the abrasive tip to the shank.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

### Embodiment 1

A dressing tool comprising a shank comprising a proximal end and a distal end; an abrasive tip comprising a superabrasive material and bonded to the distal end of the shank, the abrasive tip comprising an abrasive axis; and wherein the abrasive tip is positioned at a tilt angle of at least 1 degree relative to a longitudinal axis of the shank.

### Embodiment 2

The dressing tool of Embodiment 1, wherein the abrasive tip is bonded by a bond material comprising a carbide.

### Embodiment 3

The dressing tool of Embodiment 1, wherein the abrasive tip is bonded by a bond material comprising titanium carbide.

### Embodiment 4

The dressing tool of Embodiment 1, wherein the shank comprises a substantially cylindrical shape.

### Embodiment 5

The dressing tool of Embodiment 1, wherein the shank comprises a width in the range of 0.5 cm to 1.5 cm.

### Embodiment 6

The dressing tool of Embodiment 1, further comprising a flat surface extending for at least a portion of a length of the shank.

### Embodiment 7

The dressing tool of Embodiment 1, wherein the shank comprises a length in the range of 1.9 cm to 5.0 cm.

### Embodiment 8

The dressing tool of Embodiment 1, wherein the shank comprises a notch positioned at least one of the proximal end and the distal end.

### Embodiment 9

The dressing tool of Embodiment 8, wherein the notch comprises a top interior surface and a bottom interior surface, wherein the top interior surface and the bottom interior surface define an outer edge, and wherein the top interior surface and the bottom interior surface converge at an interior edge.

### Embodiment 10

The dressing tool of Embodiment 9, wherein the notch defines a positioning angle of less than 90 degrees.

### Embodiment 11

The dressing tool of Embodiment 9, wherein the notch defines a positioning angle of greater than 90 degrees.

### Embodiment 12

The dressing tool of Embodiment 9, wherein the notch defines a positioning angle of 90 degrees.

### Embodiment 13

The dressing tool of Embodiment 9, wherein the top interior surface is positioned at an angle not greater than 20 degrees relative to the longitudinal axis of the shank.

### Embodiment 14

The dressing tool of Embodiment 9, wherein the bottom interior surface is positioned at an angle 70 degrees or greater relative to the longitudinal axis of the shank.

### Embodiment 15

The dressing tool of Embodiment 9, wherein the shank further comprises an upper exterior surface positioned on at least one of a portion of the proximal end and a portion of the distal end.

### Embodiment 16

The dressing tool of Embodiment 9, wherein the outer edge of the top interior surface is proximal to the abrasive tip.

### Embodiment 17

The dressing tool of Embodiment 9, wherein the distance between the interior edge and the longitudinal axis is in the range of 0.10 cm to 0.16 cm.

### Embodiment 18

The dressing tool of Embodiment 15, wherein the upper exterior surface is parallel to the top interior surface.

### Embodiment 19

The dressing tool of Embodiment 15, wherein the upper exterior surface is positioned at an angle not greater than 20 degrees relative to the longitudinal axis of the shank.

### Embodiment 20

The dressing tool of Embodiment 15, wherein at least one of the upper exterior surface and the top interior surface is parallel to the abrasive axis.

### Embodiment 21

The dressing tool of Embodiment 1, wherein at least one of the proximal end and the distal end tapers.

### Embodiment 22

The dressing tool of Embodiment 1, wherein the distal end tapers to a width proportionate a width of the abrasive tip adjacent the abrasive tip.

### Embodiment 23

The dressing tool of Embodiment 1, wherein at least one of the proximal end and the distal end comprises a truncated cone shape.

### Embodiment 24

The dressing tool of Embodiment 4, wherein at least one of the proximal end and the distal end comprises a diameter proportionate to the diameter of the elongated shank portion adjacent the abrasive tip.

### Embodiment 25

The dressing tool of Embodiment 1, wherein the abrasive tip comprises a monocrystalline material.

### Embodiment 26

The dressing tool of Embodiment 1, wherein the abrasive tip is a monocrystalline material.

### Embodiment 27

The dressing tool of Embodiment 1, wherein the abrasive tip comprises a polycrystalline material.

### Embodiment 28

The dressing tool of Embodiment 1, wherein the abrasive tip is a polycrystalline material.

### Embodiment 29

The dressing tool of Embodiment 1, wherein the abrasive tip comprises diamond.

### Embodiment 30

The dressing tool of Embodiment 1, wherein the abrasive tip consists essentially of diamond.

### Embodiment 31

The dressing tool of Embodiment 1, wherein the abrasive tip comprises a length and a width, and wherein length ≥width.

### Embodiment 32

The dressing tool of Embodiment 31, wherein the length is within a range of at least 0.2 cm and not greater than 0.4 cm.

### Embodiment 33

The dressing tool of Embodiment 31, wherein the width is within a range of at least 0.15 cm and not greater than 0.21 cm.

### Embodiment 34

The dressing tool of Embodiment 1, wherein the abrasive tip is bonded to the distal end of the shank via a bonding material.

### Embodiment 35

The dressing tool of Embodiment 34, wherein the bonding material comprises a braze.

### Embodiment 36

The dressing tool of Embodiment 34, wherein the bonding material comprises titanium carbide.

### Embodiment 37

The dressing tool of Embodiment 34, wherein the bonding material consists essentially of a titanium carbide.

### Embodiment 38

The dressing tool of Embodiment 29, wherein a bonding precursor to bond the diamond and the shank comprises titanium hydride.

### Embodiment 39

The dressing tool of Embodiment 1, wherein the diamond is synthetic.

### Embodiment 40

The dressing tool of Embodiment 1, wherein the tilt angle is at least 1 degree and not greater than 30 degrees.

### Embodiment 41

The dressing tool of Embodiment 1, wherein the tilt angle is at least 2 degrees or at least 3 degrees or at least 4 degrees or at least 5 degrees or at least 6 degrees or at least 7 degrees or at least 8 degrees or at least 9 degrees or at least 10 degrees or at least 11 degrees or at least 12 degrees or at least 13 degrees, or at least 14 degrees or at least 15 degrees or at least 16 degrees or at least 17 degrees or at least 18 degrees or at least 19 degrees or at least 20 degrees or at least 21 degrees or at least 22 degrees or at least 23 degrees or at least 24 degrees or at least 25 degrees or at least 26 degrees or at least 27 degrees or at least 28 degrees or at least 29 degrees or at least 30 degrees.

### Embodiment 42

The dressing tool of Embodiment 1, wherein the tilt angle is not greater than 30 degrees or not greater than 29 degrees or not greater than 28 degrees or not greater than 27 degrees or not greater than 26 degrees or not greater than 25 degrees or not greater than 24 degrees or not greater than 23 degrees or not greater than 22 degrees or not greater than 21 degrees or not greater than 20 degrees or not greater than 19 degrees or not greater than 18 degrees or not greater than 17 degrees or not greater than 16 degrees or not greater than 15 degrees or not greater than 14 degrees or not greater than 13 degrees or not greater than 12 degrees or not greater than 11 degrees or not greater than 10 degrees or not greater than 9 degrees or not greater than 8 degrees or not greater than 7 degrees or not greater than 6 degrees or not greater than 5 degrees or not greater than 4 degrees or not greater than 3 degrees or not greater than 2 degrees or not greater than 1 degree.

### Embodiment 43

The dressing tool of Embodiment 1, wherein the tilt angle is a longitudinal tilt angle aligned along a longitudinal plane.

### Embodiment 44

The dressing tool of Embodiment 1, wherein the tilt angle is a latitudinal tilt angle aligned along a latitudinal plane.

### Embodiment 45

The dressing tool of Embodiment 1, further comprising diamond exposed at an end of the abrasive tip.

### Embodiment 46

The dressing tool of Embodiment 43, wherein the length of the diamond exposed is in the range of 0.02 cm to 0.04 cm.

### Embodiment 47

The dressing tool of Embodiment 1, wherein the abrasive tip comprises a length in the range of 0.2 cm to 0.4 cm.

### Embodiment 48

The dressing tool of Embodiment 1, wherein the abrasive tip comprises a width in the range of 0.15 cm to 0.21 cm.

### Embodiment 49

The dressing tool of Embodiment 1, wherein the abrasive tip comprises an abrasive tip chamfer angle of not greater than 30 degrees or not greater than 25 degrees or not greater than 20 degrees or not greater than 15 degrees or not greater than 10 degrees or not greater than 8 degrees or not greater than 5 degrees or not greater than 2 degrees.

### Embodiment 50

The dressing tool of Embodiment 1, wherein the abrasive tip comprises a superabrasive material and a bonding material.

### Embodiment 51

The dressing tool of Embodiment 50, wherein the bonding material is a braze.

### Embodiment 52

The dressing tool of Embodiment 50, wherein the superabrasive material comprises diamond, cubic boron nitride, synthetic diamond or a combination thereof.

### Embodiment 53

The dressing tool of Embodiment 50, wherein the superabrasive material comprises a cross-sectional shape in a plane defined by a height H1 and a width W1.

### Embodiment 54

The dressing tool of Embodiment 53, wherein the height H1 is at least 0.05 mm and not greater than 5 mm.

### Embodiment 55

The dressing tool of Embodiment 53, wherein the width W1 is at least 0.05 mm and not greater than 5 mm.

### Embodiment 56

The dressing tool of Embodiment 50, wherein the superabrasive material comprises a length L1 of at least 1 mm and not greater than 6 mm.

### Embodiment 57

The dressing tool of Embodiment 53, wherein the superabrasive material comprises a width variation not greater than 10% of an average width along at least 50% of a length L1.

### Embodiment 58

The dressing tool of Embodiment 57, wherein the superabrasive material comprises a width variation of not greater than 2% of an average width.

### Embodiment 59

The dressing tool of Embodiment 53, wherein the superabrasive material comprises a width variation of not greater than 2% of an average width along at least 80% of a length L1.

### Embodiment 60

The dressing tool of Embodiment 53, wherein the superabrasive material comprises a height variation not greater than 10% of an average height along at least 50% of a length L1.

### EXAMPLES

The properties and advantage of the present disclosure are illustrated in further detail in the following non-limiting examples.

### Components Listing

Metal for shank (Pisgah Machine Shop, Candler, N.C.).
Diamond for abrasive tip (Sumitomo).
Bond material: titanium carbide

### Example 1—Conventional Tool CS1 and Sample Tools S2-S5

A conventional tool CS1 and sample tools S2-S5 include the specific dimensions as listed in Table 1. CS1, S2 and S3 correlate to the illustrations of FIGS. 1A-1C, FIGS. 2A-2C, and FIGS. 3A-3C, respectively. Sample tool S4 correlates to the illustrations of FIGS. 3A-3C, except the longitudinal tilt angle is 11 degrees. Sample tool S5 correlates to the illustrations of FIGS. 2A-2C, except the lateral tilt angle is 10 degrees. The abrasive tip of each of CS1, S2, S3, S4 and S5 contain a Sumimoto diamond supported by a titanium carbide matrix to form the final abrasive tip.

TABLE 1
Conventional tool CS1 and Sample tools S2-S5 Specifications

| | Tool | | | | |
|---|---|---|---|---|---|
| | CS1 | Tool S2 | Tool S3 | Tool S4 | Tool S5 |
| Shank Length | 1.38 | 1.38 | 1.38 | 1.38 | 1.38 |
| (cm) | | | | | |
| Abrasive Tip | 0.12 | 0.118 | 0.118 | 0.118 | 0.118 |
| Length (cm) | | | | | |
| Abrasive Tip | 0.10 | 0.08 | 0.08 | .08 | 0.080 |
| Width (cm) | | | | | |
| Total Length | 1.5 | 1.506 | 1.506 | 1.505 | 1.505 |
| (cm) | | | | | |
| Interior edge to | 0.05 | 0.05 | 0.05 | .05 | .05 |
| Longitudinal | | | | | |
| Axis (cm) | | | | | |
| Upper Exterior | 15 | 15 | 15 | 15 | 15 |
| Surface Angle | | | | | |
| (Degrees) | | | | | |
| Width to Flat | 0.41 | 0.41 | 0.41 | 0.41 | 0.41 |
| Surface (cm) | | | | | |
| Abrasive Tip | 30 | 0 | 0 | 0 | 0 |
| Chamfer Angle | | | | | |
| (Degrees) | | | | | |
| Angle of | 0 | 15 | 15 | 11 | 10 |
| Abrasive Axis | | | | | |
| (Degrees) | | | | | |
| Plane of | N/A | Lateral | Longitudinal | Longitudinal | Lateral |
| Abrasive Tip | | | | | |
| Tilt Angle | | | | | |
| Alignment | | | | | |

TABLE 2
Performance Testing CS1 and S2-S5
Performance Test Parameters

| Wheel material | Silicon Carbide | |
|---|---|---|
| Wheel speed (rpm) | 1090 | |
| Coolant | Oil | |
| Grinding machine | Centerless Plunge | |
| | Grinders | |
| Infeed rate | <0.001 | in. |
| Material removal amount | 0.010 | in. |
| Traverse rate | 12-19 | in./min. |

CS1 was testing according to the parameters provided in Table 2 to provide a baseline understanding of performance in terms of wheel profile and ability to maintain profiles throughout its life. S4 demonstrated marked improvement compared to S1, notably having improved profiles more frequently. S3 performed notably better than S4 or CS1, providing consistent profiles and a longer tool life. Samples S2 and S5 were noted as having performances less than S3 and S4.

### Example 2: Natural vs. Synthetic

Performance testing was carried out between Sample S3 and Sample S6. Sample S6 was formed using the specifications of S3, however, a natural diamond was used instead of the Sumimoto diamond. FIG. 6 is an illustration of Sample S6. Each of the tools, S3 and S6, were run on separate machines, side by side under the same conditions according to the test parameters in Table 2.

During testing, the diamond of S6 had to be replaced 3 times. In the same time span, only 25% of the diamond of S3 was used. It is estimated the tool life of S3 was at least 12× greater than S6.

The tools of embodiments herein include a combination of features that facilitate improved grinding performance, including for example, tool design, the degree of tilt angle of the abrasive tip, plane of the tilt angle, diamond type and diamond size. It is believed the inventive tools according to embodiments herein will provide for longer tool life and an ability to maintain consistent profile requirements. This longer tool life reduces the amount of set up time and need for replacement which will, in turn, increase productivity.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A dressing tool comprising:
a shank comprising a proximal end and a distal end;
an abrasive tip comprising a superabrasive material and bonded to the distal end of the shank, the abrasive tip comprising an abrasive axis; and
wherein the abrasive tip is positioned at a tilt angle of at least 1 degree relative to a longitudinal axis of the shank.

2. The dressing tool of claim 1, wherein the tilt angle is at least 1 degree.

3. The dressing tool of claim 1, wherein the tilt angle is not greater than 30 degrees.

4. The dressing tool of claim 1, wherein the tilt angle is in range from at least 1 degree and not greater than 30 degrees.

5. The dressing tool of claim 1, wherein the tilt angle is a longitudinal tilt angle aligned along a longitudinal plane.

6. The dressing tool of claim 1, wherein the shank comprises a notch positioned at least one of the proximal end and the distal end.

7. The dressing tool of claim 1, wherein the abrasive tip comprises a length and a width, and wherein length ≥width.

8. The dressing tool of claim 7, wherein the length is within a range of at least 0.2 cm and not greater than 0.4 cm.

9. The dressing tool of claim 7, wherein the width is within a range of at least 0.15 cm and not greater than 0.21 cm.

10. The dressing tool of claim 1, wherein the abrasive tip comprises a superabrasive material and a bonding material.

11. The dressing tool of claim 10, wherein the bonding material is a braze.

12. The dressing tool of claim 10, wherein the superabrasive material comprises diamond, cubic boron nitride, synthetic diamond or a combination thereof.

13. The dressing tool of claim 10, wherein the superabrasive material comprises a cross-sectional shape in a plane defined by a height H1 and a width W1.

14. The dressing tool of claim 13, wherein the height H1 is at least 0.05 mm and not greater than 5 mm.

15. The dressing tool of claim 13, wherein the width W1 is at least 0.05 mm and not greater than 5 mm.

16. The dressing tool of claim 10, wherein the superabrasive material comprises a length L1 of at least 1 mm and not greater than 6 mm.

17. The dressing tool of claim 13, wherein the superabrasive material comprises a width variation not greater than 10% of an average width along at least 50% of a length L1.

18. The dressing tool of claim 17, wherein the superabrasive material comprises a width variation of not greater than 2% of an average width.

19. The dressing tool of claim 13, wherein the superabrasive material comprises a width variation of not greater than 2% of an average width along at least 80% of a length L1.

20. The dressing tool of claim 13, wherein the superabrasive material comprises a height variation not greater than 10% of an average height along at least 50% of a length L1.
